(19) United States
(12) Patent Application Publication
(10) Pub. No.: US 2016/0203147 A1
(43) Pub. Date: Jul. 14, 2016

(54) PAGE/SITE SERVER, PROGRAM AND METHOD FOR IMMEDIATELY DISPLAYING NOTEWORTHY PLACE IN PAGE CONTENT

(71) Applicant: KDDI CORPORATION, Tokyo (JP)

(72) Inventors: Kazushi IKEDA, Fujimino-city (JP); Gen HATTORI, Fujimino-city (JP); Yasuhiro TAKISHIMA, Fujimino-city (JP)

(73) Assignee: KDDI CORPORATION, Tokyo (JP)

(21) Appl. No.: 14/917,747

(22) PCT Filed: Sep. 19, 2014
(86) PCT No.: PCT/JP2014/074803

§ 371 Date: Mar. 9, 2016

(30) Foreign Application Priority Data
Sep. 24, 2013 (JP) 2013-196454

(51) Int. Cl. G06F 17/30; H04L 29/08; H04L 12/58

(52) U.S. Cl. CPC G06F 17/3089; H04L 51/16; H04L 67/02

(57) ABSTRACT

Provided is a page/site server and so on for immediately displaying a noteworthy place in a page content. The page/site server enables communication with a comment server allowing contributors to send their comments to one another and responds with a page content including text according to a page acquisition request transmitted from a terminal. The page/site server comprises: a comment group retriever retrieving from within the comment server a comment group related to the page content; a characteristic word extractor extracting from the comment group a characteristic word included in text of the page content with high appearance frequency under a predetermined condition; a characteristic word retriever retrieving a place where the characteristic word appears in the page content; and a browsing-part display controller controlling the objective page content to be displayed on the terminal in such a way that the place where the characteristic word appears can be browsed.

### TECHNICAL FIELD

The present invention relates to technology of a page/site server disclosing Web pages.

This application claims the benefit of priority under the Paris Convention from Japanese patent application No. 2013-196454, filed on Sep. 24, 2013, which is incorporated herein by reference in accordance with PCT rule 20.6.

### BACKGROUND ART

In recent years, a huge amount of Web page contents are disclosed through the Internet by page/site servers. The page contents are pages which many and unspecified third parties can access and which in most cases include text sentence(s)/document(s). A terminal accesses the page/site server and displays a part or (if possible) a whole of the obtained page content with a browser. The user of the terminal can browse the displayed page then to change the display range by scrolling (page-up/page-down).

Meanwhile, many and unspecified users contribute through the Internet an enormous amount of comments to site servers which process, e.g. SNS (Social Networking Service), blog (weblog) or mini blog (mini weblog) such as Twitter (registered trademark). There are many cases in which the posted comments discuss a common topic. For example, there contributed are many comments that discuss, as the common topic, the content of a page content as above-described.

There are conventional technologies which facilitate browsing of information sites which exist on networks. For example, Patent Document No. 1 discloses a technique in which automatically extracted from many information sites and displayed is an information that has a high possibility of being required by a user. The technique extracts a main body text of a title or article from each of the pre-registered information sites and preferentially provides information of information sites that carry main body texts similar to one another. When a desired information (title) is focused, its main body text is read out and pop-up displayed.

Also, Patent Document No. 2 discloses a technique where, by analyzing tags of HTML (HyperText Markup Language) in blog sites, only main bodies described by users are extracted from the blog sites. Further, Non-patent Document No. 1 discloses a technique which extracts descriptions related to the future by analyzing the structure of sentences of Web news, and then automatically arranges the extracted information in the form of a chronological table.

### CITATION LIST

### Patent Documents

Patent Document No. 1: Japanese Patent Laid-Open Publication No. 2011-150591
Patent Document No. 2: Japanese Patent No. 5068356

### Non-Patent Documents

Non-patent Document No. 1: Mitsuo Yoshida, Takashi Inui and Mikio Yamamoto, “Automatic Generation of Future Timeline using Web News Corpus”, Graduate School of Systems and Information Engineering, University of Tsukuba, [online], [Searching on Sep. 16, 2013], the Internet <URL: http://rit.rakuten.co.jp/conf/rrds3/papers/RRDS3-P-14.pdf>
Non-patent Document No. 2: “EDR Corpus”, [online], [Searching on Sep. 16, 2013], the Internet <URL: http://www2.nict.go.jp/out-promotion/techtransfer/EDR/JPN/Struct/Struct-CPS.html>

### SUMMARY OF THE INVENTION

### Problem to be Solved by the Invention

The conventional technique described in Patent Document No. 1 is designed to display on a terminal the whole of important news articles reported on plural information sites. The conventional technique described in Patent Document No. 2 is intended to display on a terminal only main bodies obtained by excluding such as advertisements and banners from Web pages. Further, the conventional technique described in Non-patent Document No. 1 is designed to display on a terminal a summary text generated by extracting portions described on a predetermined viewpoint from a news article and then summarizing the portions.

All of the above-mentioned conventional techniques require users to browse a part of the page content displayed through a browser and then change the display range by scrolling thereby to search an noteworthy sentence. If the noteworthy sentence appears at the end of the page content, the users have to scroll the page content from the head to the end.

Here, the present inventors focus on prompt display of a noteworthy place which interests every user in a page content. Especially in the case of using a terminal such as a smartphone or a tablet-type computer, it is more difficult to promptly display such a noteworthy place because of the restriction of the display size even according to the above-described conventional techniques.

It is therefore an object of the present invention to provide a page/site server, a program and a method for immediately displaying a noteworthy place which interests every user in a page content.

### Means to Solve the Problem

According to the present invention, there provided is a page/site server which enables communication with a comment server allowing plural contributors to send their comments to one another and responds with a page content including text according to a page acquisition request transmitted from a terminal, the page/site server comprising:

a comment group retriever retrieving from within the comment server a comment group related to the page content;

a characteristic word extractor extracting from the comment group a characteristic word that appears in text of the page content with a high appearance frequency under a predetermined condition;

a characteristic word retriever retrieving a place where the characteristic word appears in the page content; and

a browsing-part display controller controlling the objective page content to be displayed on the terminal in such a way that the place where the characteristic word appears can be browsed.

As an embodiment of the page/site server according to the present invention, it is preferable that the characteristic word extractor uses TF-IDF (Term Frequency-Inverse Document Frequency) method to extract from the comment group one or more characteristic words characterizing the page content as distinguished from the other ones.

As another embodiment of the page/site server according to the present invention, it is also preferable that the browsing-part display controller displays a page part including the characteristic word of the page content at a top or center of a display area of the terminal, or by direct jump to the top or center.

As another embodiment of the page/site server according to the present invention, it is also preferable that the browsing-part display controller highlights the characteristic word of the page content.

As another embodiment of the page/site server according to the present invention, it is also preferable:

that the page/site server further comprises a concept dictionary holding an information describing a conceptual system and outputting a generalized word as a broader concept word of an inputted word; and

that the characteristic word extractor extracts a plurality of characteristic words then to convert the characteristic words into generalized words by using the concept dictionary and thus to output the generalized word with a high appearance frequency as a characteristic word.

As another embodiment of the page/site server according to the present invention, it is also preferable that the page content is a content of a news article, and that the comment is transmitted from an SNS (Social Networking Service) server, a blog (Web-log) server, a bulletin board server or a review site server.

According to the present invention, there provided is a proxy server which enables communication with a comment server allowing plural contributors to send their comments to one another and with a page disclosing server disclosing page contents including text, forwards to the page disclosing server a page acquisition request received from a terminal, and then forwards to the terminal the page content received from the page disclosing server, the proxy server comprising:

a comment group retriever retrieving from within the comment server a comment group related to the page content;

a characteristic word extractor extracting from the comment group a characteristic word that appears in text of the page content with a high appearance frequency under a predetermined condition;

a characteristic word retriever retrieving a place where the characteristic word appears in the page content; and

a browsing-part display controller controlling the objective page content to be displayed on the terminal in such a way that the place where the characteristic word appears can be browsed.

According to the present invention, there provided is a program to be executed by a computer mounted on a page/site server which enables communication with a comment server allowing plural contributors to send their comments to one another and responds with a page content including text according to a page acquisition request transmitted from a terminal, the program causing the computer to function as:

a comment group retriever retrieving from within the comment server a comment group related to the page content;

a characteristic word extractor extracting from the comment group a characteristic word that appears in text of the page content with a high appearance frequency under a predetermined condition;

a characteristic word retriever retrieving a place where the characteristic word appears in the page content; and

a browsing-part display controller controlling the objective page content to be displayed on the terminal in such a way that the place where the characteristic word appears can be browsed.

According to the present invention, there provided is a page disclosing method executed in a page/site server which delivers page contents and enables communication with a comment server allowing plural contributors to send their comments to one another, the page disclosing method comprising:

a first step of retrieving from within the comment server a comment group related to the page content;

a second step of extracting from the comment group a characteristic word that appears in text of the page content with a high appearance frequency under a predetermined condition;

a third step of retrieving a place where the characteristic word appears in the page content; and

a fourth step of controlling the objective page content to be displayed on the terminal in such a way that the place where the characteristic word appears can be browsed.

### Advantageous Effects of the Invention

A page/site server, a program and a method according to the present invention enable a noteworthy place which interests every user in a page content to be displayed immediately. Especially in the case of using a terminal such as a smartphone or a tablet-type computer, the page/site server, the program and the method facilitate browsing the noteworthy place without being affected by the restriction of the display size.

### BRIEF DESCRIPTION OF DRAWINGS

The drawings are presented in which:

FIG. 1 is a configuration diagram schematically illustrating one embodiment of a system using a page/site server according to the present invention;

FIG. 2 is a functional block diagram illustrating one embodiment of a page/site server according to the present invention;

FIG. 3 is a schematic diagram showing an example of a displayed page content;

FIG. 4 is a schematic diagram showing an example of an obtained comment group related to the page content illustrated in FIG. 3;

FIG. 5 is a schematic diagram showing a first example of displaying a page content by the page disclosing method according to the present invention;

FIG. 6 is a schematic diagram showing a second example of displaying a page content by the page disclosing method according to the present invention; and

FIG. 7 is a functional block diagram illustrating one embodiment of a proxy server according to the present invention.

### EMBODIMENTS OF THE INVENTION

Illustrative embodiments of the present invention will be described below with reference to the drawings.

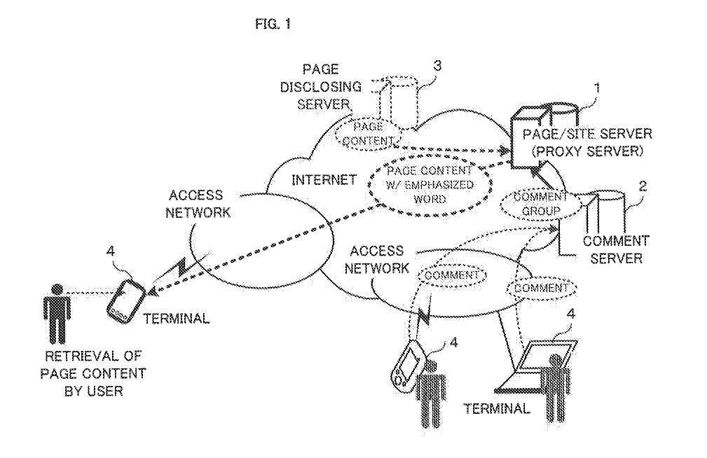

FIG. 1 is a configuration diagram schematically illustrating one embodiment of a system using a page/site server according to the present invention.

As shown in FIG. 1, a page/site server 1, a comment server 2, a page disclosing server 3 disposed as an option, and terminals 4 are interconnected through the Internet.

The page/site server 1 is configured to deliver a page content in which an noteworthy place to be observed is prepared to be displayed immediately with scrolling the page. The page content is a content which can be accessed by many and unspecified users and includes text(s) such as a news article.

The comment server 2 is a site server which enables plural contributors to send their text comments to one another. The server 2 may be, for example, an SNS (Social Networking Service) server, a blog (Web-log) server, a bulletin board server or a review site server. The comments disclosed by the comment server 2 are, for example, tweets released on the Twitter (registered trademark) sites.

As one embodiment, another page disclosing server 3 may be connected to the Internet under the configuration where a proxy server 1 is disposed at the position of the page/site server. The proxy server 1 serves as a proxy for mediating between the terminal 4 and the page disclosing server 3 and sends to the terminal 4 a page content delivered from the page disclosing server 3. To the page content, the proxy server 1 attaches a scroll control code used for immediately displaying the noteworthy place.

The terminal 4 may be, for example, a smartphone, a cellular phone, a personal computer or the like, which allows a user to browse page contents through a browser. The terminal 4 accesses the page/site server 1 thereby to display a part or (if possible) the whole of the obtained page content with the browser. According to the present invention, the noteworthy place which interests every user in the page content is displayed with the page content scrolled.

The following explanation is premised that, as shown in FIG. 1, the page/site server 1 and the comment server 2 are separately provided in the Internet. However, as an alternative, there may be installed a site server in which both functions of the page/site server and the comment server are integrated. The site server enables page contents to be disclosed in the form of adding a lot of corresponding comments to each page content. YouTube (registered trademark) is an example of a service that utilizes such a site server.

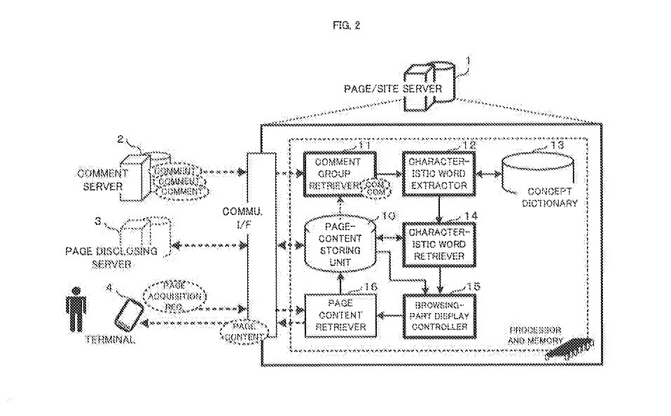

FIG. 2 is a functional block diagram illustrating one embodiment of a page/site server according to the present invention.

In the embodiment shown in FIG. 2, the page/site server 1 is constructed to include, as well as a communication interface configured to be connected to the Internet, a page-content storing unit 10, a comment group retriever 11, a characteristic word extractor 12, a concept dictionary 13, a characteristic word retriever 14, a browsing-part display controller 15, and a page content retriever 16. These functional units are embodied by executing a corresponding program on a computer mounted on the server 1. Further, the processing flow visualized by arrows connecting the functional units in the figure can be understood as an embodiment of a method for disclosing comments according to the present invention.

(Page-content storing unit 10) The page-content storing unit 10 is configured to store page contents in advance. The unit 10 may store (URLs (Uniform Resource Locators) of) new page contents gathered by using, e.g. RSS (Really Simple Syndication/Rich Site Summary).

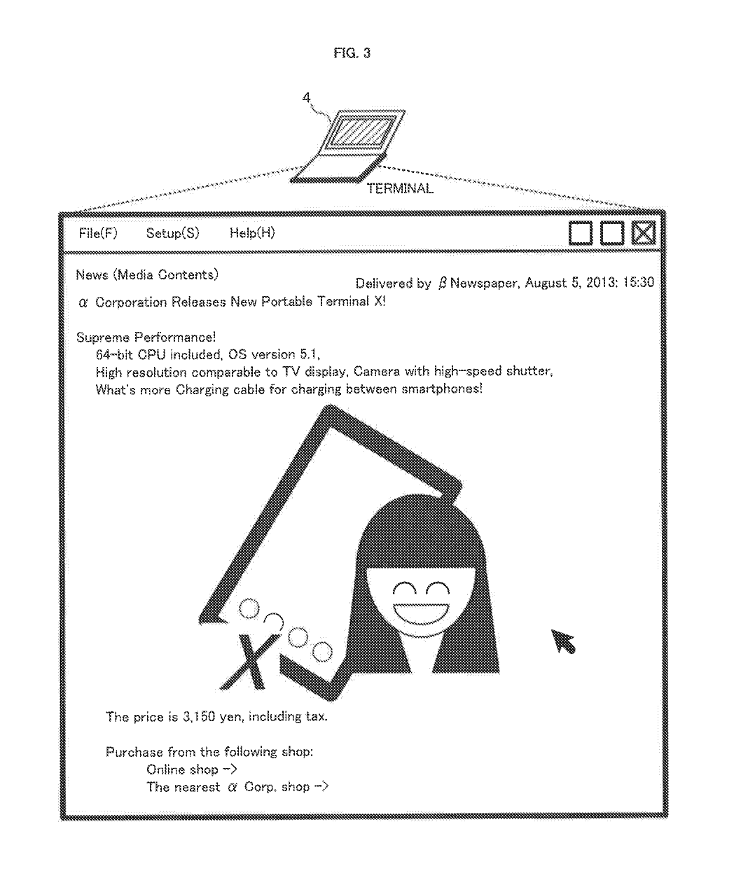

FIG. 3 is a schematic diagram showing an example of a displayed page content.

According to FIG. 3, there displayed is a page including text and an image, which announces a news whose title is “a Corporation Releases New Portable Terminal X!”.

(Comment group retriever 11) Returning to FIG. 2, the comment group retriever 11 is configured to retrieve from within the comment server 2 a comment group which includes comments related to a page content. The page content, which is stored in the page-content storing unit 10, may be one which the page content retriever 16 requests based on a page acquisition request transmitted from a terminal 4. The comment group retriever 11 uses, e.g. a URL, a title or a hush tag of the page content as a retrieval key thus to retrieve through a retrieval API (Application Programming Interface) provided as an interface for the comment server 2. For example, in the case that the page content is a news article, the comment group retriever 11 obtains a comment group including comments which are related to the news article and made from many and unspecified third parties. The retrieved comment group is outputted to the characteristic word extractor 12.

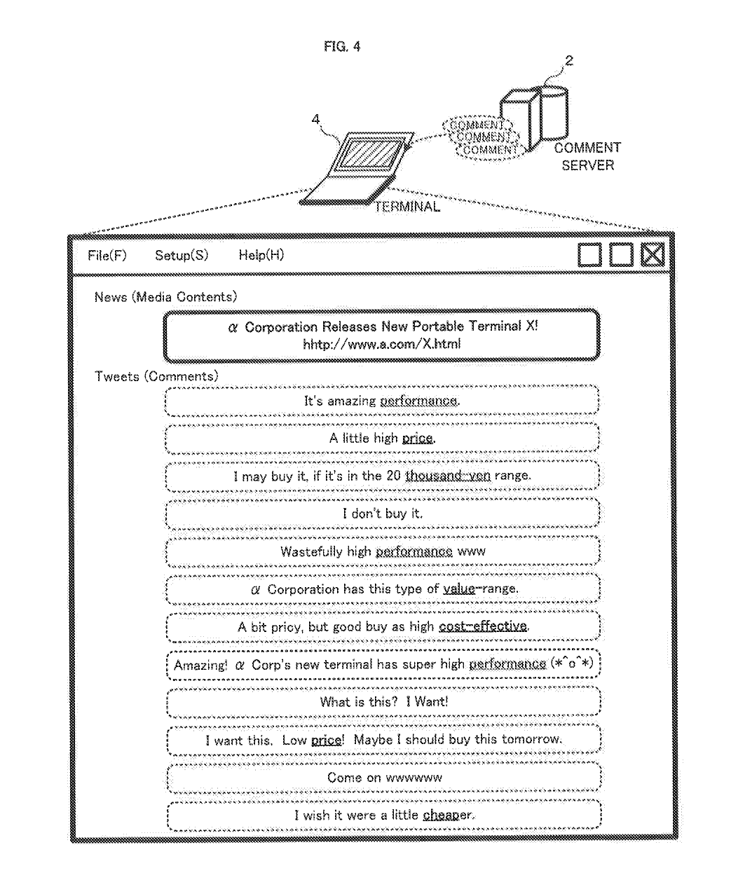

FIG. 4 is a schematic diagram showing an example of an obtained comment group related to the page content illustrated in FIG. 3.

As shown in FIG. 4, there obtained is the following comment group related to the page content shown in FIG. 3.

Page content: “α Corporation Releases New Portable Terminal X!” http://www.a.com/X.html

Comment Group:

“It's amazing performance.”;

“A little high price.”;

“I may buy it, if it's in the 20 thousand-yen range.”;

“I don't buy it.”;

“Wastefully high performance www”;

“α Corporation has this type of value-range.”;

“A bit pricy, but good buy as high cost-effective.”;

“Amazing! α Corporation's new terminal has super high performance (*̂ô*)”;

“What is this? I Want!”;

“I want this. Low price! Maybe I should buy this tomorrow.”;

“Come on wwwwww”; and

“I wish it were a little cheaper.”

(Characteristic word extractor 12) Returning to FIG. 2, the characteristic word extractor 12 is configured to extract, from the obtained comment group related to the page content, one or more “characteristic words” that appear in the text of the page content with a high appearance frequency under a predetermined condition. Here, the predetermined condition may mean that one or more characteristic words characterizing the page content as distinguished from the other ones are extracted by using TF-IDF (Term Frequency-Inverse Document Frequency) method.

The characteristic word extractor 12 is adapted to use morpheme analysis to extract words from the text included in the comment group. The “morpheme analysis” is a technique that divides a sentence into words each having a certain meaning and uses dictionaries to determine the part-of-speech or the content of each of the words. The “morpheme” means a minimal unit that is a sentence component having a certain meaning. Words that are regarded as characteristic are extracted with TF-IDF method from the words extracted by using morpheme analysis. Here, the TF-IDF method is a technique which weights each extracted word to express a sentence including the words as a vector by using a query, and ranks the extracted words by the degree of similarity between the sentence and the query. The larger the rank value given to an extracted word is, with the higher possibility the extracted word is recognized as a characteristic word. For example, the appearance frequency of each of the words included in the title or body of each news article may be used as a TF, and the appearance frequency of each of the words included in all the news articles may be used as an IDF.

According to FIG. 4, the following “characteristic word” and its “appearance frequency” are detected, for example.

| [characteristic word] | [appearance frequency] |
|---|---|
| “performance” | 3 times |
| “price” | 2 times |
| “thousand-yen” | 1 time |
| “value” | 1 time |
| “cost-effective” | 1 time |
| “cheap” | 1 time |

In the just-described example, the characteristic word “performance”, which has the highest appearance frequency, is outputted to the characteristic word retriever 14. If a characteristic word with the highest appearance frequency is not included in the page content, outputted is a characteristic word with the second highest appearance frequency.

(Concept dictionary 13) Returning to FIG. 2, the concept dictionary 13 is configured to hold information describing a conceptual system and, when inputted a word, output a generalized word (broader concept word) of the inputted word. The concept dictionary 13 may be an EDR corpus as described in Non-patent Document No. 2, for example. The EDR corpus is a group that includes corpus records, each of which is constituted by “headline information”, “sentence component information”, “morpheme information”, “sentence construction information” and “semantic information”. The semantic information describes a data expressing the relation among concepts in the form of frames and graphs.

As an alternative, the characteristic word extractor 12 may be configured to extract a plurality of characteristic words then to convert these characteristic words into generalized words by using the concept dictionary 13 and thus to output the generalized word with a high appearance frequency as a characteristic word.

In the above-described example, a plurality of characteristic words are converted into the following generalized words.

| [characteristic word]→ | [generalized word] |
|---|---|
| “performance” | “performance” |
| “price” | “value” |
| “thousand-yen” | “value” |
| “value” | “value” |
| “cost-effective” | “value” |
| “cheap” | “cheap” |

Subsequently, there calculated as follows is the appearance frequency of each of the generalized words into which the characteristic words have been converted.

| [generalized word]→ | [appearance frequency] |
|---|---|
| “value” | 5 times |
| “performance” | 3 times |
| “cheap” | 1 time |

In the just-described example, there outputted to the characteristic word retriever 14 is the generalized word “value” which has the highest appearance frequency (as well as the characteristic words “price”, “thousand yen” and “cost-effective”).

(Characteristic word retriever 14) The characteristic word retriever 14 is configured to retrieve a place where the characteristic word appears in the page content.

Here, when retrieving the appearance place of, e.g. the characteristic word “performance”, the following page-content place is retrieved from the page content shown in FIG. 3.

“Supreme ‘Performance’!”

Further, when retrieving the appearance place of, e.g. the characteristic word “value”, the following page-content place is retrieved from the same page content shown in FIG. 3.

“The ‘price’ is 3,150 yen, including tax.”

(Browsing-part display controller 15) The browsing-part display controller 15 is configured to control the objective page content to be displayed in such a way that the user can browse the appearance place of the characteristic word included in the page content. Specifically, there attached to the page content is a scroll-control code which allows the noteworthy appearance-place to be displayed immediately.

Practically, either or both of the following two displaying methods may be adapted.

(Displaying method 1) A page part including the characteristic word of the page content is displayed at the top or center of the terminal display area (by direct jump to the top or center), and in the form of being scrolled if needed.
(Displaying method 2) The characteristic word of the page content is highlighted. For example, the characteristic word may be marked with a fluorescent color then to be displayed.

FIG. 5 is a schematic diagram showing a first example of displaying a page content by the page disclosing method according to the present invention.

In the case that the characteristic word is “performance” included in the page content shown in FIG. 3, the following place in the page content is displayed at the center of the display area.

“Supreme ‘Performance’!

64-bit CPU included, OS version 5.1,

High resolution comparable to TV display, Camera with high-speed shutter,

What's more Charging cable for charging between smartphones!”

The HTML code of the place including the above-described characteristic word “performance” is as follows.

“......

Supreme </DEFANGED_span id=“highlight” style=“back

ground-color: #ffff00”>performance </DEFANGED_span>!<br/>

64-bit CPU included, OS version 5.1,<br/>
High resolution comparable to TV display, Camera with

high-speed shutter,<br/>

| | |
|---|---|
| ...... | ” |

id=“highlight”: Mark for jumping to the top (arbitrary

character string in the quotation marks)

style=“background-color: #ffff00”: Highlighting the

character background with yellow color.

Thus, the sentence line “Supreme Performance!” is searched out and displayed by referring to the following URL, for example.

http://server/test.html*highlight

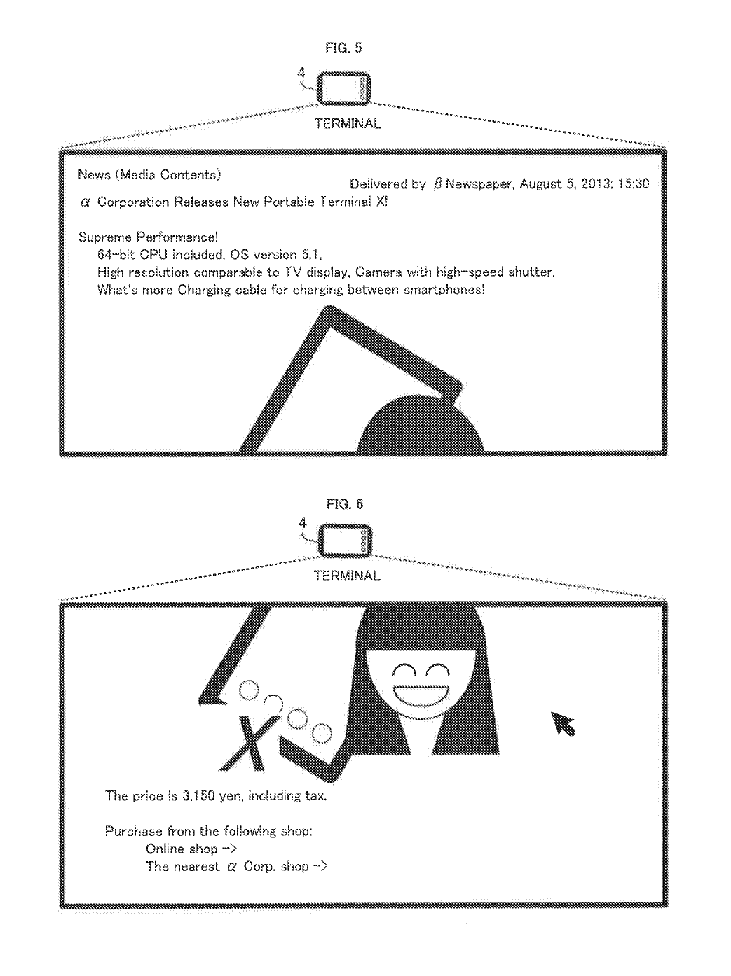

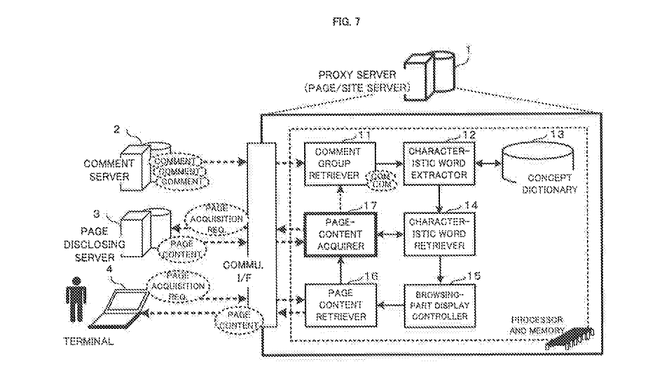

FIG. 6 is a schematic diagram showing a second example of displaying a page content by the page disclosing method according to the present invention.

In the case that the characteristic word is “value” included in the page content shown in FIG. 3, the following place in the page content is displayed at the center of the display area.

“The ‘price’ is 3,150 yen, including tax.
Purchase from the following shop:

| Online shop −> | |
|---|---|
| The nearest α Corp. shop −> | ” |

(Page content retriever 16) Returning to FIG. 2, the page content retriever 16 is configured to receive a page acquisition request transmitted from a terminal 4, to retrieve a page content which satisfies the request, then to respond to the terminal 4 with the retrieved page content. Here, the page content retriever 16 may transmit to the terminal 4 the comment group itself as well as the retrieved page content. In this case, the user browsing with the terminal 4 can know what comments have been contributed when further browsing the comment group. Alternatively, only the transmitted comment group, which includes the “characteristic word” to be displayed, may be displayed.

FIG. 7 is a functional block diagram illustrating one embodiment of a proxy server according to the present invention.

In the embodiment shown in FIG. 7, a page/site server serves as a proxy server unlike the embodiment shown in FIG. 2. Accordingly, a page content acquirer 17 is provided instead of the page-content storing unit 10 shown in FIG. 2. The page content acquirer 17 is adapted to send a page acquisition request to the page disclosing server 3 then to receive a page content as a response. The proxy server 1 attaches to the page content a scroll control code used for immediately displaying the noteworthy place to be noticed, then to send to the terminal 4 the page content as a response.

As explained above in detail, The page/site server, the program and the method according to the present invention allows immediately displaying a noteworthy place of a page content, which interests every user. Especially, when using a terminal such as a smartphone or a tablet-type computer to display a page content, the user can easily browse the noteworthy place without being affected by the limited display screen size.

Many widely different alternations and modifications of the above-described various embodiments of the present invention may be constructed without departing from the spirit and scope of the present invention. All the foregoing embodiments are byway of example of the present invention only and not intended to be limiting. Accordingly, the present invention is limited only as defined in the following claims and equivalents thereto.

### REFERENCE SIGNS LIST

1 page/site server; 10 page-content storing unit; comment group retriever; 12 characteristic word extractor; 13 concept dictionary; 14 characteristic word retriever; 15 browsing-part display controller; 16 page content retriever; 17 page content acquirer; 2 comment server; 3 page disclosing server; and 4 terminal.

What is claimed is:

1. A page/site server which enables communication with a comment server allowing contributors to send their comments to one another and responds with a page content including text according to a page acquisition request transmitted from a terminal, the page/site server comprising:
a comment group retriever retrieving from within the comment server a comment group related to the page content;
a characteristic word extractor extracting from the comment group a characteristic word that appears in text of the page content with a high appearance frequency under a predetermined condition;
a characteristic word retriever retrieving a place where the characteristic word appears in the page content; and
a browsing-part display controller controlling the objective page content to be displayed on the terminal in such a way that the place where the characteristic word appears can be browsed.

2. The page/site server as claimed in claim 1, wherein the characteristic word extractor uses TF-IDF (Term Frequency-Inverse Document Frequency) method to extract from the comment group one or more characteristic words characterizing the page content as distinguished from the other ones.

3. The page/site server as claimed in claim 1, wherein the browsing-part display controller displays a page part including the characteristic word of the page content at a top or center of a display area of the terminal, or by direct jump to the top or center.

4. The page/site server as claimed in claim 1, wherein the browsing-part display controller highlights the characteristic word of the page content.

5. The page/site server as claimed in claim 1, further comprising a concept dictionary holding an information describing a conceptual system and outputting a generalized word as a broader concept word of an inputted word,
wherein the characteristic word extractor extracts a plurality of characteristic words then to convert the characteristic words into generalized words by using the concept dictionary and thus to output the generalized word with a high appearance frequency as a characteristic word.

6. The page/site server as claimed in claim 1, wherein the page content is a content of a news article, and wherein the comment is transmitted from an SNS (Social Networking Service) server, a blog (Web-log) server, a bulletin board server or a review site server.

7. A proxy server which enables communication with a comment server allowing contributors to send their comments to one another and with a page disclosing server disclosing page contents including text, forwards to the page disclosing server a page acquisition request received from a terminal, and then forwards to the terminal the page content received from the page disclosing server, the proxy server comprising:
a comment group retriever retrieving from within the comment server a comment group related to the page content;
a characteristic word extractor extracting from the comment group a characteristic word that appears in text of the page content with a high appearance frequency under a predetermined condition;
a characteristic word retriever retrieving a place where the characteristic word appears in the page content; and
a browsing-part display controller controlling the objective page content to be displayed on the terminal in such a way that the place where the characteristic word appears can be browsed.

8. A program to be executed by a computer mounted on a page/site server which enables communication with a comment server allowing contributors to send their comments to one another and responds with a page content including text according to a page acquisition request transmitted from a terminal, the program causing the computer to function as:
a comment group retriever retrieving from within the comment server a comment group related to the page content;
a characteristic word extractor extracting from the comment group a characteristic word that appears in text of the page content with a high appearance frequency under a predetermined condition;
a characteristic word retriever retrieving a place where the characteristic word appears in the page content; and
a browsing-part display controller controlling the objective page content to be displayed on the terminal in such away that the place where the characteristic word appears can be browsed.

9. A page disclosing method executed in a page/site server which delivers page contents and enables communication with a comment server allowing contributors to send their comments to one another, the page disclosing method comprising:
a first step of retrieving from within the comment server a comment group related to the page content;
a second step of extracting from the comment group a characteristic word that appears in text of the page content with a high appearance frequency under a predetermined condition;
a third step of retrieving a place where the characteristic word appears in the page content; and
a fourth step of controlling the objective page content to be displayed on the terminal in such a way that the place where the characteristic word appears can be browsed.
